(19) United States
(12) Patent Application Publication
(10) Pub. No.: US 2006/0291475 A1
(43) Pub. Date: Dec. 28, 2006

(54) Selective forward error correction

(76) Inventor: Noam Cohen, Binyamina (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/167,555

(22) Filed: Jun. 28, 2005

(51) Int. Cl. H04L 12/56

(52) U.S. Cl. 370/395.42; 714/746; 714/751

(57) ABSTRACT

A method for selective forward error correction of a data stream is disclosed. The method comprises: identifying data segments of different importance and assigning them with corresponding levels of priority; and generating forward error correction data corresponding to only to data segments assigned with levels of priority above a predetermined level of priority.

### FIELD OF THE INVENTION

The present invention relates to video streaming. More particularly it relates to a method for selectively applying forward error correction in data streaming and in particular in video streaming.

### BACKGROUND OF THE INVENTION

The development of Video streaming over a communication network brought to a halt the long waiting time for a video file to be transferred from a remote host to a local machine. Basically video streaming means sending a video file in small data packets, that can be decoded in independent groups and thus a video file may start displaying before the entire file has reached the local machine.

Video and audio (we shell refer both to video and audio streaming as “video streaming” unless specifically indicated otherwise) are streamed from a remote server to the client. As the multimedia stream reaches the client he is able to play it in real-time (or almost real-time) as data is being received.

Video streaming involves using compressed multimedia files. Typically the most important video codec standards in video streaming are H.261, H.263, MJPEG, MPEG1, MPEG2 and MPEG4 (the last three in particular are very popular).

Generally video streaming can be found in closed-loop intranets but video streaming is increasingly becoming a main entertainment technology over the Web and other large networks.

Streaming of video (typically over IP networks using UDP—user datagram protocol—format, but this is not the only form of data streaming) or other data streaming may have problems due to packet loss and other non-ideal network characteristics. Even a well-planned network, without over-subscription, can suffer packet losses, jitter and arrival of packets in the wrong order.

These problems can cause significant degradation of the perceived video quality at the terminal (the set-top-box, or STB).

In MPEG format a Video Elementary Stream (VES) is subjected to GOP (Group Of Pictures) encoding. To deal with temporal redundancy, MPEG divides the frames into groups, each referred to as a “group of pictures,” or GOP. A VES is made up of I, P and B type pictures. An I picture (I stands for Intracoded picture) contains information of a whole new frame and is used as reference in the reconstruction of either P or B pictures, whereas a P (P stands for Predicted picture) picture contains information on several consecutive intermediate frames sharing information from the I picture. A P picture supports forward prediction from a previous picture. A B picture (B stands for Bi-directional prediction picture) contains only information of a single intermediate frame. A B picture is a forward, backward or bi-directional picture, referring to other I and P pictures. For example, the extent of the damage caused by a lost packet depends on its location: if the packet is inside an I picture, artifacts will be visible until the showing of the next I picture—usually about 0.5 second. If the lost packet is in P picture, the damage will be for about 3 pictures (frames) duration (typically 120 mSec), and if in B picture, only for the duration of that picture (typically 40 mSec).

Modern decoders have error concealment capabilities. When a missing data is detected, the decoder can display data from the previous picture to conceal the error.

The usefulness of error concealment depends also on the location of the lost packets. If several packets are lost in neighboring pictures, the decoder might not have the reference information it needs for successfully performing error concealment.

If many packets are lost but their distribution is wide, the decoder may have enough information so that the video stream will not show any artifacts. This hints that the ratio of packet lost to total packets is not good enough in evaluating system performance.

As data communication over a network is prone to errors, data packets may be corrupted or lost and therefore error correction is required in video streaming.

Several types of error correction techniques are known.

Packet retransmit correction is a method in which the sender receives feedback from the client and responds by resending the lost or corrupted data packets. This method imposes heavy requirements on terminal and server buffer size and server complexity. Inherently the missing data packets may arrive too late for the decoder to be able to use them on time.

Forward error correction (FEC) is another correction method in which the sender adds error correction codes to the transmitted data bytes. Although this method uses additional data and therefore requires adding certain overhead (extra information), it gives rise to a certain level of instant error recovery, which does not depend on resending of information by the sender (as in the packet transmit case).

The present invention relates mainly to forward error correction. Forward error correction is done by adding redundant data like parity. The protection level obtained is a function of the overhead added: It is possible to change (dynamically) the amount of parity data according to the required protection level.

Normally FEC works by adding one parity packet for every N packets of data. If one of the N data packets is lost, the other N-1 data packets and the added parity packet are used to reconstruct the lost data. If more than one packet is lost than the parity information contained in the parity is not enough for reconstructing the lost data rendering this scheme unfit for use. RFC 2733 (“An RTP Payload Format for Generic Forward Error correction”, ”J. Rosenberg dynamicsoft, H. Schulzrinne Columbia University, December 1999”) describes a method to construct general purpose FEC with real time protocol (RTP) packetization.

The overhead added in FEC depends on the desired protection level and is based on the estimated/predicted network error rate.

For example, if one wants to protect against one packet loss out of every 100 packets, and assuming therefore that the gap between two lost packets is bigger than 100, then one parity packet is placed after 100 data packets. When a packet loss is identified (this is typically done using RTP sequence number), the reconstructor (the decoder) has to process 100 packets in order to reconstruct the lost packet.

An improvement to the above simple method is to use two dimensional ordering of FEC codes. This method allows reconstruction of lost packets even if they are close to each other, as can happen when a router drops a series of packets.

The following example shows a possible organization of FEC packets (taken from SMPTE Motion Imaging Journal, February/March 2005, page 84). Consider FIG. 1, illustrating a matrix of L*D RTP packets, each group of L packets assigned a FEC parity packet.

With the organization described in this figure, if packet 0 and packet 1 are lost (as is probable if the router drops a ‘batch’ of UDP packets) then the FEC′ 0 packet is unable to help, but the data can still be reconstructed using FEC 0 and FEC 1.

There are packet loss patterns that are not recoverable by this mechanism. For example, if two packets in a row and two packets in another row in the same columns are lost, then both corresponding horizontal and vertical FEC become useless.

The price to pay for achieving better error recovery is a higher overhead. For example, if L=D=10, the overhead is typically about 20% of the effective data (in this example the amount of data=10*10 packets, and amount of overhead=10+10). This value may be too high to be used for a video application where bandwidth is used almost to the maximum.

In practice, a value of L=6, D=4 or similar single digit values would be more appropriate for video streaming, but other values are acceptable too and in no way limit the scope of this invention.

It is an object of the present invention to provide a method for selectively applying FEC in data streaming.

Another object of the present invention is to provide a method for selectively applying FEC particularly in video streaming.

Yet another object of the present invention is to provide such method that utilizes tagging data packets corresponding to their designated priority so as to allow immediate distinction between packets of different priorities (for example, high, medium or low hierarchy).

Another object of the present invention is to provide a method for forward error correction that may be used as a working solution for better error recovery in scenarios where the bandwidth is heavily used.

Another object of the present invention is to provide a method for selective FEC, which is capable of protecting only information of high hierarchy (for example only I pictures, or only I and P pictures).

Yet another object of the present invention is to provide a method for adaptive FEC, which is capable of dynamically adjusting to varying communication limitations.

Other objects and advantages of the present invention will become clear after reading the present specification and considering the accompanying drawings.

### SUMMARY OF THE INVENTION

There is thus provided, in accordance with some preferred embodiments of the present invention, a method for selective forward error correction of a data stream, the method comprising:

identifying data segments of different importance and assigning them with corresponding levels of priority; and

generating forward error correction data corresponding to only to data segments assigned with levels of priority above a predetermined level of priority.

Furthermore, in accordance with some preferred embodiments of the present invention, assigning the data segments with corresponding levels of priority comprises tagging data segments.

Furthermore, in accordance with some preferred embodiments of the present invention, all data segments are tagged.

Furthermore, in accordance with some preferred embodiments of the present invention, the data stream is a video stream.

Furthermore, in accordance with some preferred embodiments of the present invention, the video stream comprises video stream from the group containing MPEG1, MPEG2, MPEG4, SMPTE VC-1, and QUICK TIME.

Furthermore, in accordance with some preferred embodiments of the present invention, the data segments comprises data packets.

Furthermore, in accordance with some preferred embodiments of the present invention, the data segments comprise IP packets.

Furthermore, in accordance with some preferred embodiments of the present invention, the data segments comprise ATM packets.

Furthermore, in accordance with some preferred embodiments of the present invention, the identification of the data segments and the generation of forward error correction data are done by separate entities.

Furthermore, in accordance with some preferred embodiments of the present invention, the levels of priority comprise two levels of priority.

Furthermore, in accordance with some preferred embodiments of the present invention, the levels of priority comprise three or more levels of priority.

Furthermore, in accordance with some preferred embodiments of the present invention, forward error correction data is transmitted during transmission of unprotected data segments.

Furthermore, in accordance with some preferred embodiments of the present invention, there is provided a method for selective processing of a data stream, the method comprising:

identifying data segments of different importance and assigning them with corresponding levels of priority; and

tagging the data segments according to the corresponding levels of priority.

Furthermore, in accordance with some preferred embodiments of the present invention, there is provided a device for selective forward error correction of a data stream, the device comprising:

an indexer for identifying data segments of the data stream of different importance and assigning them with corresponding levels of priority; and

a forward error correction generator for generating forward error correction data corresponding to only to data segments assigned with levels of priority above a predetermined level of priority.

Furthermore, in accordance with some preferred embodiments of the present invention, the indexer further tags the data segments according to their levels of priority.

Furthermore, in accordance with some preferred embodiments of the present invention, the device is incorporated in a video streaming system.

Furthermore, in accordance with some preferred embodiments of the present invention, the indexer and the forward error correction generator are separate entities.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 (PRIOR ART) illustrates an FEC treated video stream of packets. It is represented by a matrix of L*D RTP packets, each group of L packets assigned a FEC parity packet.

FIG. 2 schematically illustrates selectively adding FEC packets only to selected portions of the stream, in accordance with a preferred embodiment of the present invention.

FIG. 3 illustrates smoothing of data transmission during adaptive selective application of FEC on data streaming, in accordance with a preferred embodiment of the present invention.

FIG. 4 illustrates an apparatus on a transmitting end implementing selective forward error correction, in accordance with a preferred embodiment of the present invention.

FIG. 5 illustrates a receiver apparatus implementing selective forward error correction, in accordance with a preferred embodiment of the present invention.

### DETAILED DESCRIPTION OF PREFERRED EMBODIMENTS

A main aspect of the present invention is the application of selective forward error correction to data streaming.

The selective application of FEC to data stream has a particular appeal when trying to economize on the bandwidth, and provide good protection against packets loss at lower overhead.

In order to facilitate this protection data stream packets are assigned priorities, the priorities corresponding to the relative importance of each data packet.

For example, when considering MPEG (or SMPTE VC-1) video streaming, data packets containing information relating to an I picture are considered to be of higher priority than data packets that do not contain information relating to an I picture.

Moreover, one may further distinct between data packets that do not contain information relating to an I picture, but contain information relating to a P-picture, from packets that contain only information relating to a B-picture.

Accordingly, data packets containing information relating to an I-picture are tagged as a high-priority, distinguishing them from other data packets.

In another preferred embodiment of the present invention subsidiary distinction between data packets that do not contain information relating to an I picture, but contain information relating to a P-picture, and packets that contain only information relating to a B-picture is suggested, by tagging them differently (or but tagging only one type of these data packets).

For example, one may assign numbers as tags, for example one may tag data packets containing information on an I-picture by the numeral 1, tag data packets that do not contain information relating to an I picture, but contain information relating to a P-picture by the numeral 2 and tag packets that contain only information relating to a B-picture by the numeral 3 (or leave the last type of packets untagged).

Tagging of data packets can be made, for example, by setting the IP header field DSCP to video type with an additional subtype specifying the priority level of the data packet. The DSCP byte is part of the IP header. It can be used to signify the relative importance of the data payload, for example, specifying that the data payload contains data from an I picture. Alternatively, tagging can be made using appropriate byte or bytes in the footer, or other places in the data packet.

Both the PRO-MPEG code of practice (COP) # 3, and IETF RFC 2733 operate on data packets in the UDP layer (layer 3 in the OSI model). The IP header tagging (using the DSCP byte) is done in layer 2, therefore tagged stream according to the present invention using the DSCP byte is compatible with the above standards. Notwithstanding the above, other ways of tagging are still covered by the scope of the present invention.

The operations involved in the process described hereinabove may be carried out by the same device or be divided between two or more devices.

If the identification of data packets is carried out internally by the same device that generates FEC packets tagging would not be necessary, since the device will directly generate FEC packets relating to data packets, based on the identification. However if the generation of FEC packets is done externally by another device tagging is necessary for the other device to generate FEC packets properly.

Now that there is distinction between data packets of different hierarchy (relating to their priority) forward error correction can be applied selectively.

By “selectively”, in the context of the present invention, it is meant that instead of sending FEC packets containing information on all the data packets of the data stream, FEC packets are issued and sent relating only to selected data packets.

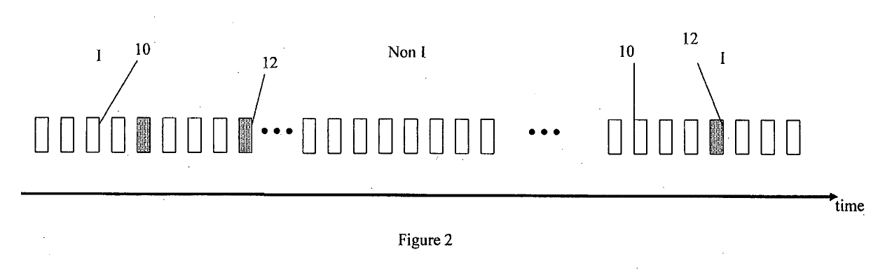

In some preferred embodiments of the present invention a data stream is assigned only two levels of priority, and FEC packets are issued only for data packets of the higher priority. For example, in an MPEG stream, only packets containing information relating to an I-picture (10) get a FEC packet (12) (see FIG. 2).

In other preferred embodiment of the present invention, a data stream is assigned more than two levels of priority, and FEC packets are issued selectively only for data packets of higher priorities. For example, in MPEG where data packets containing information on an I-picture are tagged “1”, and where data packets that do not contain information relating to an I picture are tagged “2” (and where packets that contain only information relating to a B-picture are either tagged “3” or not tagged at all), only packets containing information on an I-picture are assigned higher priority, and FEC packets are issued only for those data packets that are marked as high priority (1) and for those packets that are tagged as higher priority (2).

Moreover, as in fact loss of the early P-pictures following a certain I-picture have greater impact than loss of latter p-pictures. Consequently, it may be wise to assign higher priority to earlier p-pictures with respect to other p-pictures that follow in the same GOP. The present invention may be, therefore, implemented by setting more than three levels of priority.

In cases where data stream packets are assigned more than two priority levels it is further suggested to perform dynamically adaptive FEC. By “dynamically adaptive” it is meant, in the context of the present invention, dynamic application of FEC, which takes into account the bandwidth and anticipated volumes of communications through it.

This means that when the anticipated data communication is heavy, only highest priority (e.g. data packets tagged “1”) are issued FEC packets, whereas other lower priority data packets do not receive this treatment. When the anticipated data traffic is more lenient lower priority data packets get to be protected by FEC packets (e.g. packets tagged by “1” and “2”).

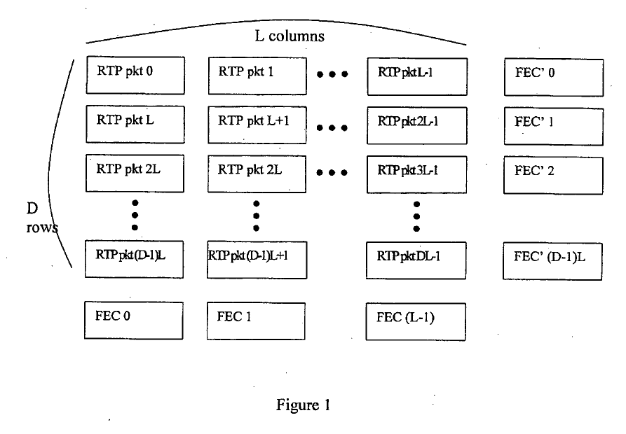

The server (or alternatively other an intermediary device) can be programmed to automatically select the protection period (in other words the value of L and D, see FIG. 1), and further programmed to select which data packets are to be protected (according to their assigned priority) in a dynamic manner.

The decision when to change from protecting only highest priority data packets to protecting also lower priority data packets can be made automatically, on-line, or be predetermined according to a predefines set of rules.

Selective application of FEC brings about a more economical approach to overhead. As opposed to conventional FEC on MPEG, which typically brings about an overhead of about 20%, applying selective FEC significantly reduces overhead attributed to FEC protection, and according to some preferred embodiments of the present invention, the overhead may be reduced to about 2-4%.

The effect on the client is effectively negligible, as the client code is unaware to the selection criteria. The selective application of FEC requires only modification of software on the server (or on an intermediate device). The client has only to implement a standard protocol.

The client may be a simple client whose decoder is incapable of dealing with error correction, in which case the error correction data will be simply ignored by the client. A more advanced client with a decoder that can implement error correction information will be able to use the error correction data to reconstruct lost data.

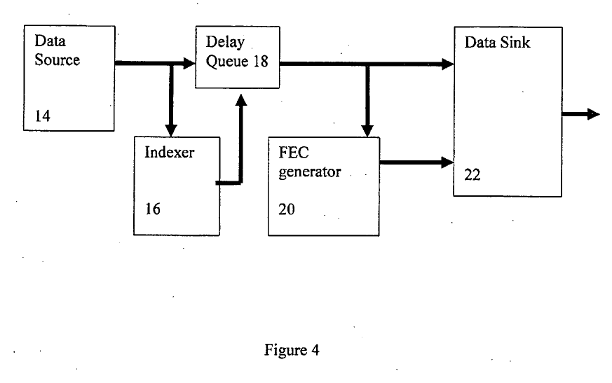

FIG. 4 illustrates an apparatus on a transmitting end implementing selective forward error correction, in accordance with a preferred embodiment of the present invention. Data (e.g. MPEG stream) is passed from the Data source (14) to the indexer (16) and Delay Queue (18). The indexer (16) identifies the segments in the data stream that have higher priority (based on a predetermined rule or rules) and sends this information to the delay Queue (18), which tags the data (e.g. using meta data tag glued to a data sample).

The data is streamed into the (20), which creates FEC packets and passes them to the data sink (22). The original data bytes (which are unmodified) are passed directly to the data sink (22), which consequently transmits the data with the FEC packets to the client or clients.

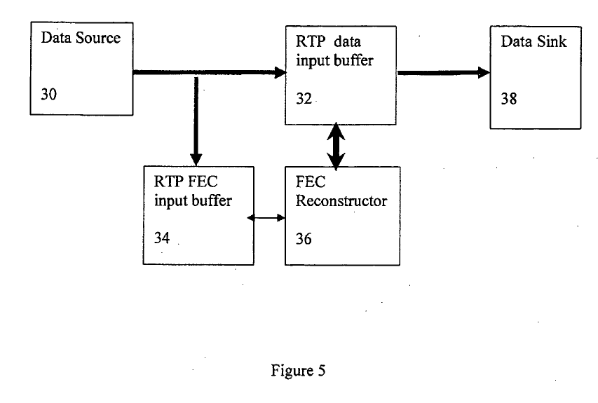

FIG. 5 illustrates a receiver apparatus implementing selective forward error correction, in accordance with a preferred embodiment of the present invention.

Data stream and FEC packets are received by the data source (30) (e.g. a network socket) and are stored in the data input buffer (32) and FEC input buffer (34) respectively.

The FEC reconstructor (36) examines the data headers and if a packet loss is identified (by identifying discontinuity in the sequence number attached to each packet), a corrective action is initiated: The corrective action is comprised of identifying the data packets protected by a given FEC packet and reconstructing, if at all possible, the lost packet and placing it in the correct order in the data input buffer.

The data stream, either corrected or not, is then passed downstream to the next processing stage (e.g. MPEG decoder), symbolized here as the data sink (38).

The inventor of present invention considers the priority tagging of data stream packets to be a novel aspect on its own, and that feature is significant and may be used in any data stream (not only in video streaming) for applications other than FEC, where it is wise to treat data packets distinctly, with respect to different priority levels.

According to some preferred embodiments of the present invention the server may add forward error correction code according to a fixed policy or according to a dynamically changing policy. For example, the server may add 20% of parity packets assigned for I packets, add 10% for P packets and add nothing for B packets), and it can also adapt in real time to instantaneously changing network conditions. This adaptation can also be based on a feedback from the terminal. The terminal can measure the statistics of packet losses (as well as other data), process packets and send feedback to the server.

The feedback can be done for example using RTCP, RTSP or any other mechanism.

If the server has information on the packet loss statistics, it can be made to choose a matching FEC configuration

In the example shown in FIG. 1, both L and D values can be changed—resulting in controlled overhead.

When data packets are tagged, as suggested hereinabove the terminal (“terminal” and “client” are interchangeable terms in the context of the present invention) receives data packets and examines the sequence number. It can even predict when it is not worth the effort of reconstructing by knowing the place where the particular packet had been lost: if it decides that recovery is impossible then there is no point wasting CPU on trying. This situation is seen in the example of FIG. 1 if the packets numbered 0, 1, L are lost. In this case, packet 0 cannot be reconstructed. A process to perform reconstruction is detailed in RFC 2733, incorporated herein by reference.

If the creation of the FEC packets (typically done by performing XOR operation between L packets for each FEC packets) is straining the video streamer, it can be done on an external device. The device, which is an intermediate device between the server and the client, can be unaware to MPEG: it only has to look at the DSCP byte and generate the FEC according to the format to be specified.

The present invention further suggests implementing adaptive FEC by smoothing FEC transmission over the data stream.

As seen in FIG. 1, for every L*D data packets, the transmitter sends L+D FEC packets (if full protection is required) or L FEC packets if only interleaved FEC is configured.

For example, for the protected data, setting the configuration to L=4, D=5 means that for every 20 data packets, there will be 4 FEC packets which leads to a 20% overhead.

If D is larger the overhead is lower but the buffering requirements will be higher accordingly.

In DSL lines (as well as in other types of networks), it is desired to keep the utilized bandwidth more or less constant.

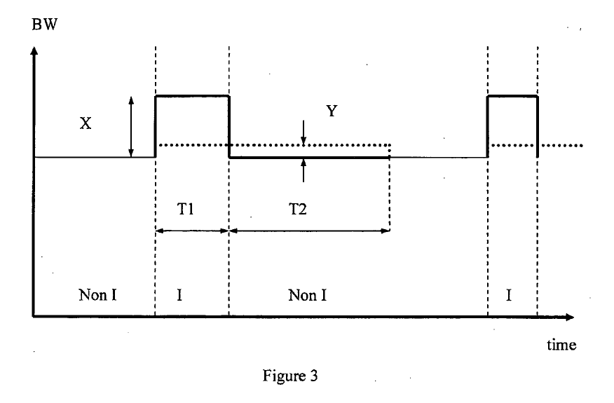

To keep this requirement, a smoothing buffer of the FEC can be used. FIG. 3 shows a plot depicting bandwidth use over time, when not using smoothing (Solid line) and with smoothing (denoted by the dotted line over time T1 and T2).

The additional bandwidth during transmission of the protected data is denoted by X. To limit the increase in bandwidth to Y, the FEC packets are sent interleaved with the data for duration of T1+T2.

T1 is the duration that the I picture is transmitted. This value is normally larger than the presentation time (typically 40 mSec in PAL) and depends on the I picture size. In common encoded streams T1 is up to 100 mSec.

The amount of FEC bytes is T1*X. Therefore the duration of increased bandwidth is denoted by T1+T2=T1*X/Y.

For example, for T1=100 mSec, X=20%, Y=5% time duration T1+T2 is 100*20/5=400 mSec.

Note that T1+T2 must be shorter than or equal to the time between successive I pictures (normally 500 mSec). The time duration T1+T2 influences the buffering requirements in the receiver, influencing latency as well.

It is noted and emphasized that although the examples given hereinabove relate to video streams, the present invention can be implemented on data stream of any kind, with data bits of different importance, where it is advantageous to treat the data bits differently with respect to their importance.

As to the tagging suggested in the present invention, it is noted that it may be implemented not only on packetized data streams, but also on bulk data. It is also possible to implement the tagging and FEC procedure suggested in the present invention on bulk data that is packetized during the processing.

It should be cleat that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for selective forward error correction of a data stream, the method comprising:
identifying data segments of different importance and assigning them with corresponding levels of priority;
generating forward error correction data corresponding to only to data segments assigned with levels of priority above a predetermined level of priority.

2. The method of claim 1, wherein assigning the data segments with corresponding levels of priority comprises tagging data segments.

3. The method of claim 2, wherein all data segments are tagged.

4. The method of claim 1, wherein the data stream is a video stream.

5. The method of claim 4, wherein the video stream comprises video stream from the group containing MPEG1, MPEG2, MPEG4, SMPTE VC-1, and QUICK TIME.

6. The method of claim 1, wherein the data segments comprises data packets.

7. The method of claim 6, wherein the data segments comprise IP packets.

8. The method of claim 6, wherein the data segments comprise ATM packets.

9. The method of claim 1, wherein the identification of the data segments and the generation of forward error correction data are done by separate entities.

10. The method of claim 1, wherein the levels of priority comprise two levels of priority.

11. The method of claim 1, wherein the levels of priority comprise three or more levels of priority.

12. The method of claim 1, wherein forward error correction data is transmitted during transmission of unprotected data segments.

13. A method for selective processing of a data stream, the method comprising:
identifying data segments of different importance and assigning them with corresponding levels of priority;
tagging the data segments according to the corresponding levels of priority.

14. A device for selective forward error correction of a data stream, the device comprising:
an indexer for identifying data segments of the data stream of different importance and assigning them with corresponding levels of priority;
a forward error correction generator for generating forward error correction data corresponding to only to data segments assigned with levels of priority above a predetermined level of priority.

15. The device of claim 14, wherein the indexer further tags the data segments according to their levels of priority.

16. The device of claim 14, incorporated in a video streaming system.

17. The device of claim 14, wherein the indexer and the forward error correction generator are separate entities.
